(19) United States
(12) Patent Application Publication
(10) Pub. No.: US 2005/0124739 A1
(43) Pub. Date: Jun. 9, 2005

(54) Sheet and formed product thereof

(75) Inventors: Minoru Oda, Isezaki-shi (JP); Takeshi Miyakawa, Isezaki-shi (JP); Hideaki Nishimura, Ichihara-shi (JP); Kohji Taneichi, Ichihara-shi (JP); Kazuyoshi Ebe, Ichihara-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Denki Kagaku Kogyo Kabushiki Kaisha, Tokyo, (JP)

(21) Appl. No.: 10/505,447

(22) PCT Filed: Feb. 27, 2003
(86) PCT No.: PCT/JP03/02220

(30) Foreign Application Priority Data
Mar. 1, 2002 (JP) 2002-055255
Sep. 6, 2002 (JP) 2002-261213

(51) Int. Cl. C08L 1/00

(52) U.S. Cl. 524/238

(57) ABSTRACT

A sheet excellent in antistatic properties, transparency and impact strength, and a formed product thereof. The sheet is made of a resin composition comprising an elastomeric styrene polymer and component (B) in a mass ratio of from 98/2 to 80/20, wherein the elastomeric styrene polymer comprises styrene monomer units, (meth)acrylate monomer units, etc., and component (B) comprises (B1) an amino carboxylic acid having at least 6 carbon atoms, a lactam, or a salt of a diamine with a carboxylic acid, having at least 6 carbon atoms, (B2) at least one diol compound and (B3) a polyether ester amide having a C?4-20#191 dicarboxylic acid copolymerized.

### TECHNICAL FIELD

The present invention relates to a sheet and a formed product thereof. More particularly, it relates to a sheet excellent in antistatic properties, transparency, impact strength, etc., and a formed product thereof, such as an electronic component packaging container.

### BACKGROUND ART

A styrene resin is used in a wide range including various packaging materials, containers and formed products. As the application fields have expanded, it has been desired to improve the impact strength of a styrene polymer. As a styrene polymer having the impact strength improved, a styrene polymer containing an elastomer as dispersed particles, i.e. an elastomeric styrene polymer, is known to be a transparent resin excellent in balance and is referred to as transparent ABS. The present invention provides a sheet employing such transparent ABS and a formed product thereof. The prior art relating to the present invention includes, for example, JP-A-2001-106258, JP-A-2000-238878 and JP-A-2000-154257.

The present invention provides a sheet excellent in transparency, impact strength, antistatic properties, etc., which-employs an elastomeric styrene polymer comprising a continuous phase of a copolymer comprising styrene monomer units and (meth)acrylate monomer units, and a dispersed phase of an elastomer, and a formed product such as an electronic component packaging container, employing such a sheet.

### DISCLOSURE OF THE INVENTION

The present invention provides:

1. A sheet made of a resin composition comprising the following elastomeric styrene polymer, and component (B1), component (B2) and component (B3), in a mass ratio of from 98/2 to 80/20:
Elastomeric styrene polymer: An elastomeric styrene polymer which comprises (I) from 40 to 95 parts by mass of a continuous phase of a copolymer comprising from 20 to 80 mass % of styrene monomer units, from 80 to 20 mass % of (meth)acrylate monomer units and from 0 to 10 mass % of units of other vinyl monomers copolymerizable with such monomers, and (II) from 60 to 5 parts by mass of a dispersed phase of a graft copolymer having from 20 to 90 parts by mass of graft branches of a copolymer comprising from 20 to 80 mass % of styrene monomer units, from 80 to 20 mass % of (meth)acrylate monomer units and from 0 to 10 mass % of units of other vinyl monomers copolymerizable with such monomers, grafted to from 10 to 80 parts by mass of an elastomer, wherein the volume average particle size of the dispersed phase is from 0.1 to 0.6 μm, and the difference in the refractive index between the continuous phase and the dispersed phase is not more than 0.05;
Component (B1): An aminocarboxylic acid having at least 6 carbon atoms, a lactam, or a salt of a diamine with a carboxylic acid, having at least 6 carbon atoms;
Component (B2): At least one diol compound selected from the following chemical formulae (1) to (3): 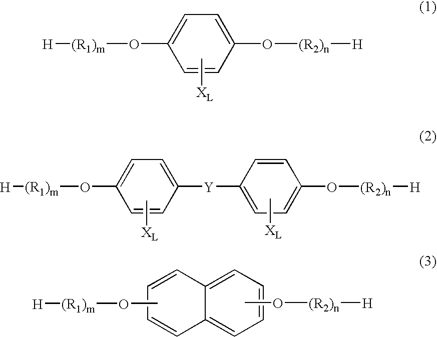
   wherein R₁ is an ethylene oxide group, R₂ is an ethylene oxide group or a propylene oxide group, Y is a covalent bond, a C₁₋₆ alkylene group, a C₁₋₆ alkylidene group, a C₇₋₁₇ cycloalkylidene group, a C₇₋₁₇ arylalkylidene group, O, SO, SO₂, CO, S, CF₂, C(CF₃)₂ or NH, L in XL is an integer of from 1 to 4, and each of m and n is an integer of at least 16;
Component (B3): A polyether ester amide having a C₄₋₂₀ dicarboxylic acid copolymerized.

2. A multilayer sheet which comprises a substrate layer made of a thermoplastic resin (C) and a surface layer made of the resin composition as defined in Item 1, formed on at least one side of the substrate layer.

3. The multilayer sheet according to Item 2, wherein the substrate layer is made of the following elastomeric styrene polymer:
Elastomeric styrene polymer: An elastomeric styrene polymer which comprises (I) from 40 to 95 parts by mass of a continuous phase of a copolymer comprising from 20 to 80 mass % of styrene monomer units, from 80 to 20 mass % of (meth)acrylate monomer units and from 0 to 10 mass % of units of other vinyl monomers copolymerizable with such monomers, and (II) from 60 to 5 parts by mass of a dispersed phase of a graft copolymer having from 20 to 90 parts by mass of graft branches of a copolymer comprising from 20 to 80 mass % of styrene monomer units, from 80 to 20 mass % of (meth)acrylate monomer units and from 0 to 10 mass % of units of other vinyl monomers copolymerizable with such monomers, grafted to from 10 to 80 parts by mass of an elastomer, wherein the volume average particle size of the dispersed phase is from 0.1 to 0.6 μm, and the difference in the refractive index between the continuous phase and the dispersed phase is not more than 0.05.

4. The multilayer sheet according to Item 2, wherein the substrate layer is made of the following component (D):
Component (D): An elastomeric styrene polymer which comprises from 99 to 85 parts by mass of a continuous phase comprising from 35 to 75 mass % of styrene monomer units and from 65 to 25 mass % of (meth)arylate monomer units, and from 1 to 15 parts by mass of a dispersed phase of an elastomer.

5. A multilayer sheet which comprises a substrate layer of an elastomeric styrene polymer comprising from 1 to 20 parts by mass of a dispersed phase of an elastomer comprising from 30 to 50 mass % of styrene monomer units and from 70 to 50 mass % of butadiene monomer units, and from 99 to 80 parts by mass of a continuous phase of a polymer comprising from 35 to 75 mass % of styrene monomer units and from 65 to 25 mass % of (meth)acrylate monomer units, and a surface layer of a styrene polymer comprising from 35 to 75 mass % of styrene monomer units and from 65 to 25 mass % of (meth)arylate monomer units, formed on each side of the substrate layer.

6. The sheet according to Item 5, wherein the styrene polymer comprises at most 3 parts by mass of a dispersed phase of an elastomer comprising from 30 to 50 mass % of styrene monomer units and from 70 to 50 mass % of butadiene monomer units, and from 97 to less than 100 parts by mass of a continuous phase of a polymer comprising styrene monomer units and (meth)arylate monomer units.

7. The sheet according to any one of Items 2 to 6, wherein the total thickness is from 50 to 2,000 μm, and the thickness of the surface layer is from 3 to 20% of the total thickness.

8. The sheet according to any one of Items 5 to 7, wherein the refractive index of the surface layer at 25° C. is within a range of +0.01 of the refractive index of the substrate layer.

9. A formed product which comprises the sheet as defined in any one of Items 1 to 8.

10. An electronic component packaging container which comprises the sheet as defined in any one of Items 1 to 8.

11. A food product packaging container which comprises the sheet as defined in any one of Items 1 to 8.

12. An embossed carrier tape which comprises the sheet as defined in any one of Items 1 to 8.

13. A soft tray which comprises the sheet as defined in any one of Items 1 to 8.

14. An electronic component package which comprises the sheet as defined in any one of Items 1 to 8.

### BRIEF DESCRIPTION OF THE DRAWINGS

FIG. 1 is a cross-sectional view of a formed product obtained by vacuum forming in Examples.

FIG. 2 is a schematic view illustrating the impact test of a formed product obtained by vacuum forming in Examples.

### EXPLANATION OF SYMBOL

A: Center portion of the bottom surface of the formed product

### BEST MODE FOR CARRYING OUT THE INVENTION

The elastomeric styrene polymer comprises a continuous phase of a copolymer comprising styrene monomer units and (meth)acrylate monomer units, and a dispersed phase employing an elastomer. The copolymer constituting the continuous phase in the elastomeric styrene polymer, is a copolymer comprising styrene monomer units and (meth)acrylate monomer units, which may further contain units of other vinyl monomers copolymerizable with such monomers.

The styrene monomer is styrene or its derivative. The derivative may, for example, be α-methylstyrene, p-methylstyrene, o-methylstyrene or p-t-butylstyrene. Preferred is styrene. Such styrene monomers may be used alone in combination as a mixture of two or more of them.

The (meth)acrylate monomer is an acrylate or a methacrylate, such as methyl methacrylate, ethyl methacrylate, methyl acrylate, ethyl acrylate, n-butyl acrylate, 2-methylhexyl acrylate, 2-ethylhexyl acrylate or octyl acrylate. Such (meth)acrylate monomers may be used alone or in combination as a mixture of two or more of them.

Other vinyl monomers copolymerizable with the styrene monomer and the (meth)acrylate monomer, include, for example, acrylic acid, methacrylic acid, acrylonitrile, methacrylonitrile, fumaronitrile, maleimide, N-phenylmaleimide and N-cyclohexylmaleimide. Preferred are methacrylic acid, acrylonitrile and N-phenylmaleimide.

The graft copolymer constituting the dispersed phase is a copolymer obtained by grafting a copolymer comprising styrene monomer units, (meth)acrylate monomer units and, optionally, units of other vinyl monomers copolymerizable with such monomers, to an elastomer.

The elastomer may, for example, be polybutadiene, a styrene/butadiene block copolymer, a styrene/isoprene block copolymer, a styrene/butadiene random copolymer, a styrene/isoprene random copolymer or a graft copolymer thereof.

Sheet Employing Elastomeric Styrene Polymer

The elastomeric styrene polymer can be used in the form of a single layer or multilayer sheet. The multilayer sheet comprises a substrate layer and a surface layer formed on at least one side of the substrate layer. It may, for example, be in the form of a substrate layer/surface layer or a surface layer/substrate layer/surface layer. Preferred is a construction of a surface layer/substrate layer/surface layer. Another layer may be inserted between the surface layer and the substrate layer. By insertion of such another layer, the secondary forming property, rigidity, etc., may be modified. Further, in order to improve the adhesion between the surface layer and the substrate layer, another layer may be inserted. The elastomeric styrene polymer may be used for any one of these layers, or for a plurality of such layers.

According to the present invention, by incorporating specific additives to the above-mentioned specific elastomeric styrene polymer, it is possible to obtain a sheet excellent in transparency, impact strength and antistatic properties. The elastomeric styrene polymer to be used in the present invention comprises (I) from 40 to 95 parts by mass, preferably from 60 to 95 parts by mass, of a continuous phase of a copolymer comprising from 20 to 80 mass % of styrene monomer units, from 80 to 20 mass % of (meth)acrylate monomer units and from 0 to 10 mass % of units of other vinyl monomers copolymerizable with such monomers, and (II) from 60 to 5 parts by mass, preferably from 40 to 5 parts by mass, of a dispersed phase of a graft copolymer having from 20 to 90 parts by mass of graft branches of a copolymer comprising from 20 to 80 mass % of styrene monomer units, from 80 to 20 mass % of (meth)acrylate monomer units and from 0 to 10 mass % of units of other vinyl monomers copolymerizable with such monomers, grafted to from 10 to 80 parts by mass of an elastomer.

The volume average particle size of the above dispersed phase is from 0.1 to 0.6 μm, preferably from 0.1 to 0.4 μm, and the difference in the refractive index between the continuous phase and the dispersed phase is not more than 0.05. If the volume average particle size is made small, the impact strength tends to deteriorate, and if it is made large, the transparency tends to deteriorate. The volume average particle size is a volume based median diameter, as measured by a light scattering medium distribution measuring apparatus by dispersing the elastomeric styrene polymer in N,N-dimethylformamide (DMF). Further, it is possible to measure the dispersed particle size of the soft component comprising an elastomer as the main component in the elastomeric styrene polymer, in the same manner. If the continuous phase increases, the impact strength of the sheet or the packaging container, tends to deteriorate. If it decreases, the forming property and transparency of the sheet tend to deteriorate.

In order to maintain good transparency of a sheet or packaging container employing the elastomeric styrene polymer, the difference between the refractive index of the continuous phase and the refractive index of the dispersed phase, is preferably not more than 0.05, particularly not more than 0.03.

The specific additives to be used in the present invention are the following components (B1), (B2) and (B3).

Component (B1) is an aminocarboxylic acid having at least 6 carbon atoms, a lactam, or a salt of a diamine with a carboxylic acid, having at least 6 carbon atoms. The amino carboxylic acid having at least 6 carbon atoms is preferably ω-aminocaproic acid, ω-aminocaprylic acid, ω-aminoenanthic acid or 1,2-aminododecanoic acid, and the lactam is preferably caprolactam, enantlactam or capryllactam. The salt of a diamine with a dicarboxylic acid, having at least 6 carbon atoms, is preferably a hexamethylenediamine/adipic acid salt, a hexamethylenediamine/sebacic acid salt or a hexamethylenediamine/isophthalic acid salt. Particularly preferred is caprolactam, 1,2-aminododecanoic acid or a hexamethylenediamine/adipic acid salt.

Component (B2) is at least one diol compound selected from the following chemical formulae (1) to (3): 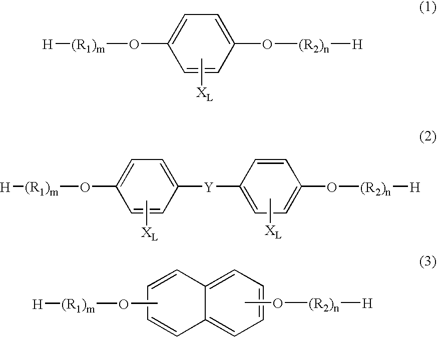
wherein R₁ is an ethylene oxide group, R₂ is an ethylene oxide group or a propylene oxide group, Y is a covalent bond, a C₁₋₆ alkylene group, a C₁₋₆ alkylidene group, a C₇₋₁₇ cycloalkylidene group, a C₇₋₁₇ arylalkylidene group, O, SO, SO₂, CO, S, CF₂, C(CF₃)₂ or NH, L in X_{L} is an integer of from 1 to 4, and each of m and n is an integer of at least 16.

Specific examples include an ethylene oxide and/or propylene oxide adduct of bisphenol A, an ethylene oxide and/or propylene oxide adduct of 2,2-bis(4,4′-hydroxycyclohexyl)propane, an ethylene oxide and/or propylene oxide adduct of dimethylbisphenol A, an ethylene oxide and/or propylene oxide adduct of tetramethylbisphenol A, an ethylene oxide and/or propylene oxide adduct of 2,2-bis(4,4′-hydroxyphenyl-3,3′-sodiumsulfonate)propane, an ethylene oxide and/or propylene oxide adduct of bisphenol S, an ethylene oxide and/or propylene oxide adduct of 4,4-((hydroxy)biphenyl, an ethylene oxide and/or propylene oxide adduct of bis(4-hydroxyphenyl)sulfide, an ethylene oxide and/or propylene oxide adduct of bis(4-hydroxyphenyl)methane, an ethylene oxide and/or propylene oxide adduct of 1,1-bis(4-hydroxyphenyl)amine, an ethylene oxide and/or propylene oxide adduct of 1,1-bis(4-hydroxyphenyl)ether, an ethylene oxide and/or propylene oxide adduct of 1,1-bis(4-hydroxyphenyl)cyclohexane, an ethylene oxide and/or propylene oxide adduct of 1,1-bis(4-hydroxyphenyl)cyclohexane, an ethylene oxide and/or propylene oxide adduct of 1,4-dihydroxycyclohexane, an ethylene oxide and/or propylene oxide adduct of hydroquinone, an ethylene oxide and/or propylene oxide adduct of dihydroxynaphthalene, and block copolymers thereof.

Preferred diol compounds are an ethylene oxide adduct of hydroquinone, an ethylene oxide adduct of bisphenol A, an ethylene oxide adduct of bisphenol S, an ethylene oxide adduct of dihydroxynaphthalene and their block copolymers. Particularly preferred are an ethylene oxide adduct of bisphenol A and its block copolymers.

Component (B3) is a polyether ester amide having a C₄₋₂₀ dicarboxylic acid copolymerized. The dicarboxylic acid may, for example, be a C₄₋₂₀, preferably C₄₋₁₄, dicarboxylic acid, and it is preferably an aromatic dicarboxylic acid such as terephthalic acid, isophthalic acid, phthalic acid, naphthalene-2,6-dicarboxylic acid or naphthalene-2,7-dicarboxylic acid, an alicyclic carboxylic acid such as 1,4-cyclohexanedicarboxylic acid or 1,2-cyclohexanedicarboxylic acid, succinic acid, oxalic acid, adipic acid or sebacic acid.

By adding components (B1), (B2) and (B3) to the elastomeric styrene polymer, the antistatic properties can be improved. The proportion of components (B1), (B2) and (B3) to the elastomeric styrene polymer is such that the ratio (mass ratio) of the elastomeric styrene polymer/total amount of components (B1), (B2) and (B3), is preferably from 98/2 to 80/20, particularly preferably from 97/2 to 83/17. If the proportion of components (B1), (B2) and (B3) is increased, the impact strength may sometimes decrease.

There is no particular restriction as to the method for mixing the elastomeric styrene polymer with components (B1), (B2) and (B3). For example, premixing may be carried out by a known mixing apparatus such as a Henschel mixer or a tumbler mixer, followed by melt-kneading by means of an extruder such as a single screw or twin screw extruder, whereby they can be uniformly mixed.

In the present invention, the resin composition having the specific additives incorporated to the specific elastomeric styrene polymer, can be used as a single layer or multilayer sheet. In the multilayer sheet, such a resin composition is preferably used as a surface layer. Whereas, for the substrate layer, the above resin composition may be employed, or another different thermoplastic resin may be employed. As such a thermoplastic resin, a polystyrene resin, a polyolefin resin, a polycarbonate resin, a polyester resin, an ABS resin, an acrylic resin, a polyamide resin, a polyphenylene ether resin, a polyurethane resin, a polyvinyl chloride resin or their alloy resins, may, for example, be used.

In the present invention, in order to obtain a sheet having good transparency and forming properties, it is advisable to use for the substrate layer the above elastomeric styrene polymer, or a elastomeric styrene polymer comprising from 99 to 85 parts by mass of a continuous phase comprising from 35 to 75 mass % of styrene monomer units and from 65 to 25 mass % of (meth)acrylate monomer units, and from 1 to 15 parts by mass of a dispersed phase of an elastomer.

Now, another embodiment of the sheet of the present invention will be described.

Namely, it is a multilayer sheet which comprises a surface layer/a substrate layer/a surface layer wherein the elastomeric styrene polymer is used for the substrate layer and which is excellent in transparency. For the surface layer, a styrene polymer is employed which is a polymer comprising from 35 to 75 mass % of styrene monomer units and from 65 to 25 mass % of (meth)acrylate monomer units. For the substrate layer, an elastomeric styrene polymer is employed which comprises from 1 to 20 parts by mass of a dispersed phase comprising from 30 to 50 mass % of styrene monomer units and from 70 to 50 mass % of butadiene monomer units, and from 99 to 80 parts by mass of a continuous phase of a polymer comprising from 35 to 75 mass % of styrene monomer units and from 65 to 25 mass % of (meth)acrylate monomer units.

To the styrene polymer for the surface layer, an elastomer may be added in an amount of not more than 3 parts by mass without impairing the properties such as transparency. The elastomer contained in the elastomeric styrene polymer is preferably from 1 to 20 parts by mass. If the elastomer is less than 1 part by mass, excellent impact strength can hardly be obtained, and if it exceeds 20 parts by mass, the transparency or forming properties tend to deteriorate, such being undesirable.

The mass ratio of the styrene monomer units to the (meth)acrylate monomer units, constituting the continuous phase of the elastomeric styrene polymer, is usually 35-75:65-25, preferably 42-59:58-41.

The elastomer for the above sheet is preferably one containing styrene and butadiene as the main constituting components. Particularly preferred is a styrene/butadiene block copolymer. The weight ratio of the styrene monomer units to the butadiene monomer units in such a styrene/butadiene block copolymer, is preferably 30-50:70-50. The weight average molecular weight (Mw) of the polystyrene portions is preferably within a range of from 45,000 to 75,000. The ratio (Mw/Mn) of the weight average molecular weight (Mw) to the number average molecular weight (Mn), is preferably from 1.20 to 1.80. Within such a range, the elastomeric styrene polymer will have excellent transparency. The molecular weight of the polystyrene portions can be obtained by measuring by GPC a polystyrene obtained by subjecting the styrene/butadiene block copolymer to ozone decomposition by a method disclosed in literature “RUBBERCHEMISTRY AND TECHNOLOGY”, Vol. 58, p. 16 (Y. Tanaka, et. al., 1985), and the molecular weight corresponding to each peak can be obtained from a calibration curve prepared by using standard polystyrene.

The styrene/butadiene block copolymer can be obtained, for example, by polymerizing a styrene monomer with a butadiene monomer in an organic solvent by using an organic lithium compound as an initiator under specific conditions. As the organic solvent, a known organic solvent may be used such as, an aliphatic hydrocarbon such as butane, pentane, hexane, isopentane, heptane, octane or isooctane, an alicyclic hydrocarbon such as cyclopentane, methylcyclopentane, cyclohexane, methylcyclohexane or ethylcyclohexane, or an aromatic hydrocarbon such as benzene, toluene, ethylbenzene or xylene. The organic lithium compound is a compound having at least one lithium atom bonded in its molecule, and ethyllithium, n-propyllithium, isopropyllithium, n-butyllithium, sec-butyllithium or t-butyllithium may, for example, be used.

The weight average molecular weight (Mw) of the polystyrene portions in the styrene/butadiene block copolymer can be controlled by adjusting the ratio of the amount of the initiator to the amount of the styrene monomer and the butadiene monomer. The ratio (Mw/Mn) of the weight average molecular weight (Mw) to the number average molecular weight (Mn) of the polystyrene portions in the styrene/butadiene block copolymer, can be controlled by adding an organic acid such as acetic acid or stearic acid, an alcohol such as ethanol or butanol, or a deactivating agent such as water with adjustment of the amount or the timing during the polymerization.

Further, a higher fatty acid metal salt and/or a higher fatty acid ester and/or a polyethylene wax may be incorporated within a range not to impair the performance of the elastomeric styrene polymer. Other types of elastomers may also be added within a range not to bring about deterioration of the transparency.

In the present invention, the thickness of the sheet is not particularly limited, and it is usually from 50 to 2,000 μm. In the case of a multilayer sheet, the thickness of the surface layer is preferably within a range of from 3 to 20% of the thickness of the entire sheet. If it is less than 3%, it tends to be difficult to obtain a uniform structure constantly in the multilayer formation in the processing of the sheet. If it exceeds 20%, in the case of a surface layer with a small elastomer content, the physical properties of the sheet or the productivity of the sheet tends to deteriorate due to the notch effect, such being undesirable.

Methods for Producing the Elastomeric Styrene Polymer and the Styrene Polymer

For the production of the elastomeric styrene polymer and the styrene polymer, common bulk polymerization, solution polymerization, suspension polymerization, emulsion polymerization or the like may be employed. Either a batch polymerization method or a continuous polymerization may be employed. In such a polymerization method, as the polymerization initiator, an azo compound such as azobisbutyronitrile or azobiscyclohexanecarbonitrile, or an organic peroxide such as benzoyl peroxide, t-butyl peroxybenzoate, t-butyl peroxy-2-ethyl hexanoate, di-t-butyl peroxide, dicumyl peroxide or ethyl-3,3-di(t-butylperoxy)butyrate, may, for example, be used. As a molecular weight modifier, t-dodecylmercaptan, n-dodecylmercaptan or 4-methyl-2,4-diphenylpentene-1 may be added, and as a plasticizer, butylbenzyl phthalate may, for example, be added as the case requires.

Method for Producing a Sheet

The method for producing the sheet of the present invention is not particularly limited, and a known method for producing a multilayer sheet can be employed. It can be produced under usual sheeting conditions by means of various resin forming apparatus for lamination, for example, by laminate fusion by a calender apparatus or a T-die extruder, or by means of a sheet extruder provided with a multi manifold die or a feed block capable of simultaneously extruding the surface layers and the interlayer.

Addition of a Third Component

To the resin constituting the sheet, additives such as an antioxidant, a weather resistant agent, a lubricant, a plasticizer, a colorant, an antistatic agent, a mineral oil, a flame retardant, etc., may be added, as the case requires. Further, in order to improve the surface properties of the sheet, an antistatic agent, silicone, an antifogging agent or the like, may be coated on the surface.

Forming of the Sheet

The sheet of the present invention may be formed into various packaging containers. For example, air-pressure forming, press forming or vacuum forming may be mentioned. Among them, vacuum forming is preferred. For a deep drawing shape, a plug assisted forming system capable of assisting the shaping is used in many cases. As such a plug assisted forming system, a forming system such as plug assisted forming, plug assisted reverse draw forming or plug assisted air slip forming may, for example, be mentioned.

From the viewpoint of the productivity and economical efficiency, recycling of scrap materials is common in the forming of the sheet. In such a case, in order to maintain the transparency of the final sheet, it is advisable to select for the surface layer a material which has a good compatibility and a refractive index close to the elastomeric styrene polymer to constitute the substrate layer. Specifically, the difference between the refractive index of the surface layer and the refractive index of the substrate layer at 25° C. is preferably within +0.01. By so matching the refractive indices, the sheet and its formed product may be recovered as it is without separating the surface layer and the substrate layer and may be melt-formed to obtain a transparent formed product. Accordingly, it can be used as a transparent sheet suitable for recycling and safe to the environment.

In the present invention, the sheet is useful for a formed product. It is useful in various product fields for vacuum forming including industrial component packaging containers, IC magazines or carrier tapes and food packaging containers such as cups for ice creams, beverages, etc. The sheet of the present invention is particularly suitable for application to electronic component packaging containers.

The electronic component packaging container is a container for packaging an electronic component, and it may, for example, be a vacuum-formed tray, a soft tray or a carrier tape (an embossed carrier tape). Such a container can be produced by subjecting the sheet to vacuum forming, air-pressure forming or press forming. The sheet of the present invention is useful particularly for an embossed carrier tape.

The electronic component is not particularly limited. It may, for example, be IC, LED (light-emitting diode), a resistor, a liquid crystal, a capacitor, a transistor, a piezoelectric element resistor, a filter, a quartz oscillator, a quartz resonator, a diode, a connector, a switch, a volume, a relay or an inductor. The type of IC is not particularly limited, and SOP, HEMT, SQFP, BGA, CSP, SOJ, QFP or PLCC may, for example, be mentioned.

The electronic component package means one having an electronic component packaged by the electronic component packaging container. The electronic component is accommodated in an electronic component packaging container such as a vacuum-formed tray or a carrier tape (an embossed carrier tape) and then used. The carrier tape includes one having covered with a covering tape after accommodating the electronic component.

### EXAMPLES

The following methods were used for various evaluations in the following Examples. In the following description, “parts” and “%” mean “parts by mass” and “mass %”, respectively.

Impact Strength

In accordance with JIS K7211, a falling weight test was carried out to measure the impact strength.

Transparency

In accordance with JIS K7105, the total light transmittance and the haze were measured by means of a haze meter.

Surface Resistivity

In accordance with JIS K6911, the surface resistivity of the sheet was measured.

Forming Property for a Carrier Tape

A sheet was slit to have a width of 27 mm and subjected to forming by an air-pressure forming machine to obtain an embossed carrier tape having a width of 24 mm, whereby the shaping property of the sheet was evaluated.

A1(I) and A2(II) for an elastomeric styrene polymer having compositions as identified in Table 1 were melt-kneaded by means of a twin screw extruder to prepare pellets of an elastomeric styrene polymer.

TABLE 1

| | | Proportions of monomers (%) | | | | | | |
|---|---|---|---|---|---|---|---|---|
| | Proportion | | | Copolymerizable | Proportion | | Volume | |
| | of | Styrene | (meth)acrylate | other vinyl | of | | average | |
| | copolymer | monomer | monomer | monomer | elastomer | Graft | particle | Refractive |
| | (%) | Styrene | MMA | AN | (%) | ratio (%) | size (μm) | index |
| (A1) | 100 | 23.1 | 73 | 0 | — | — | — | 1.519 |
| (A2) | 35.2 | 24.2 | 75.8 | 0 | 64.8 | 97.2 | 0.2 | 1.518 |

Component (B) was prepared by using 50 parts by mass of caprolactam (B1), 35 parts by mass of 32 mol ethylene oxide adduct of bisphenol A (B2) and 15 parts by mass of adipic acid (B3), as materials. Here, the refractive index was 1.520.

Component (D) was prepared by using 55 parts by mass of styrene, 34 parts by mass of methyl methacrylate, 5 parts by mass of n-butyl acrylate and 6 parts by mass of a styrene/butadiene copolymer, as materials.

### Example 1

The elastomeric styrene polymer and component (B) were mixed in the proportions as identified in Table 2 by a Henschel mixer and formed into a single layer sheet having a thickness of 300 μm by means of a φ40 mm extruder (L/D=26) and a T-die of 600 mm in width. An evaluation test of this sheet was carried out. The evaluation results are shown in Table 3.

### Example 2

Using as a surface layer material a resin having the elastomeric styrene polymer and component (B) mixed in the proportions as shown in Table 2 by a Henschel mixer, and using the elastomeric styrene polymer for a substrate layer, a 3 layer sheet having a thickness of 300 μm was prepared by a feed block method by means of a φ40 mm extruder (L/D=26) and a T-die of 600 mm in width. An evaluation test of this sheet was carried out. The evaluation results are shown in Table 3.

### Example 3

Using as a surface layer material a resin having the elastomeric styrene polymer and component (B) mixed in the proportions as shown in Table 2 by a Henschel mixer and using component (D) for a substrate layer, a 3 layer sheet having a thickness of 300 μm was prepared by a feed block method by means of a φ40 mm extruder (L/D=26) and a T-die of 600 mm in width. An evaluation test of this sheet was carried out. The evaluation results are shown in Table 3.

### Comparative Examples 1 and 2

The elastomeric styrene polymer and component (B) were mixed in the proportions as shown in Table 2 by a Henschel mixer and then formed into a single layer sheet having a thickness of 300 μm by means of a φ40 mm extruder (L/D=26) and a T-die of 600 mm in width. An evaluation test of this sheet was carried out. The evaluation results are shown in Table 3.

TABLE 2

| | Proportion of | |
|---|---|---|
| | elastomeric | |
| | styrene | Proportion |
| | polymer (%) | of (B) (%) |
| Example 1 | 88 | 12 |
| Example 2 | 88 | 12 |
| Example 3 | 88 | 12 |
| Comparative | 99 | 1 |
| Example 1 | | |
| Comparative | 78 | 22 |
| Example 2 | | |

TABLE 3

| | | | Total | | | | |
|---|---|---|---|---|---|---|---|
| | Impact | | light | | | | Surface |
| | strength | Haze | transmittance | Forming properties | | | resistivity |
| | (N) | (%) | (%) | 170° C. | 190° C. | 210° C. | (Ω/□) |
| Example 1 | 0.71 | 3.5 | 85 | Fair | Good | Good | 1 × 10¹⁰ |
| Example 2 | 0.88 | 3.1 | 85 | Good | Excellent | Excellent | 4 × 10¹⁰ |
| Example 3 | 0.91 | 3.1 | 85 | Good | Good | Excellent | 4 × 10¹⁰ |
| Comparative | 0.82 | 3.1 | 85 | Fair | Fair | Good | >10¹⁴ |
| Example 1 | | | | | | | |
| Comparative | 0.11 | 2.1 | 84 | Fair | Fair | Fair | 3 × 10¹⁰ |
| Example 2 | | | | | | | |

As shown above, it is possible to obtain a sheet excellent in transparency and having antistatic properties, by mixing a polyether ester amide to a resin component comprising the elastomeric styrene polymer and a copolymer having specific constituting monomers and constituting amounts.

Now, Examples will be shown for a multilayer sheet comprising a surface layer/substrate layer/surface layer wherein the elastomeric styrene polymer is used for the substrate layer. Firstly, the production of styrene polymers used in Examples and Comparative Examples will be described.

Elastomeric Styrene Polymer 1

To a monomer mixture comprising 58.5 parts of styrene (St), 36.0 parts of methyl methacrylate (MMA) and 5.5 parts of n-butyl acrylate (n-BA), 10.0 parts of a styrene/butadiene block copolymer A (content of styrene monomer units: 40%, Mw of the polystyrene portions: 62,500, Mw/Mn=1.52) was dissolved, and 0.04 part of benzoyl peroxide was added as a polymerization initiator, and 0.2 part of t-dodecylmercaptan was added as a chain transfer agent. The mixture was heated at 90° C. for 8 hours with stirring and then cooled to terminate bulk polymerization. Then, to the reaction mixture, 0.2 part of dicumyl peroxide was added anew as a polymerization initiator. To 200 parts of pure water, 0.001 part of sodium dodecylbenzenesulfonate and 0.5 part of tribasic calcium phosphate were added as suspension stabilizers, and with stirring, the reaction mixture was dispersed.

Then, this mixture was subjected to heat polymerization at 100° C. for 2 hours, at 115° C. for 3.5 hours and at 130° C. for 2.5 hours. After completion of the reaction, washing, dehydration and drying were carried out to obtain an elastomeric styrene polymer (copolymer 1) in the form of beads. Then, the obtained beads-form polymer was subjected to extrusion by a twin screw extruder (TEM-35B, manufactured by Toshiba Machine Co., Ltd.) at a cylinder temperature of 220° C. to obtain a pelletized elastomeric styrene polymer (P1). The composition of P1 is shown in Table 4. Its physical properties are shown in Table 5.

Styrene Polymer 2

To a monomer mixture comprising 54 parts of styrene and 46.0 parts of methyl methacrylate, 0.04 part of benzoyl peroxide as a polymerization initiator and 0.2 part of t-dodecylmercaptan as a chain transfer agent, were added. The mixture was heated at 90° C. for 8 hours with stirring and then cooled to terminate bulk polymerization. The subsequent operation was carried out in the same manner as in the preparation of P1 to obtain a beads-form modified styrene polymer, and further, extrusion was carried out by means of a twin screw extruder (TEM-35B, manufactured by Toshiba Machine Co., Ltd.) at a cylinder temperature of 220° C. to obtain a pelletized styrene polymer (P2). The composition of the obtained P2 is shown in Table 4, and its physical properties are shown in Table 5.

Styrene Polymer 3

MS resin DENKA TX polymer, TX-400-300L, tradename, was used as P3 for a test. The composition of P3 is shown in Table 4, and its physical properties are shown in Table 5.

Elastomeric Styrene Polymer 4

39 Parts of butadiene, 26 parts of styrene, 150 parts of pure water, 0.5 part of potassium oleate, 0.13 part of t-butyl hydroperoxide, 0.03 part of Rongalit, 0.002 part of ferrous sulfate, 0.003 part of sodium ethylenediamine tetraacetate, 0.1 part of sodium pyrophosphate and 1.0 part of t-dodecylmercaptan were charged into an autoclave equipped with a stirrer and polymerized at a temperature of 45° C. for 17 hours.

The number average particle size of the obtained styrene/butadiene rubber latex was 0.08 μm. To the latex, 0.005 part of sodium sulfosuccinate was added for stabilization. To this latex, an aqueous solution of hydrogen chloride was added with stirring to flocculate and grow latex particles and thereby to obtain a rubber latex having a number average particle size of 0.2 μm.

To this latex, 19.5 parts of styrene, 13.5 parts of MMA, 2 parts of n-butyl acrylate, 0.04 part of divinylbenzene, 0.5 part of t-butylphenol and 0.5 part of dilauryl thiopropionate were added, and then, a copolymer was precipitated by hydrochloric acid, followed by neutralization, washing, dehydration and drying to obtain powdery copolymer 2. Then, copolymer 1 and copolymer 2 were uniformly mixed at a ratio of 80/20 and subjected to extrusion by means of a twin screw extruder (TEM-35B, manufactured by Toshiba Machine Co., Ltd.) at a cylinder temperature of 220° C. to obtain a pelletized elastomeric styrene polymer (P4). The composition of the obtained P4 is shown in Table 4, and its physical properties are shown in Table 5.

Styrene Polymer 5

Polystyrene resin (GPPS) Denkastyrol, MW-1-301, tradename, was used as P5 for a test. The composition of P5 is shown in Table 4, and its physical properties are shown in Table 5.

Now, the preparation of a multilayer sheet will be described.

TABLE 4

| | Ratio of constituting | | | | |
|---|---|---|---|---|---|
| | units (mass %) | | | | |
| | Styrene | Acrylate | | Content of | Content of |
| | monomer | monomer | | elastomer | copolymer 2 |
| | St | MMA | n-BA | (mass %) | (mass %) |
| P1 | 58.6 | 35.9 | 5.5 | 9.8 | 0 |
| P2 | 52.9 | 48.1 | 0 | 0 | 0 |
| P3 | 42 | 58 | 0 | 0 | 0 |
| P4 | 58.6 | 36.0 | 5.4 | 7.8 | 20 |
| P5 | 100 | 0 | 0 | 0 | 0 |

TABLE 5

Physical properties

| | Izod impact | | | |
|---|---|---|---|---|
| Styrene | strength | MFR | Haze | Refractive |
| copolymer | (kJ/m²) | (g/10 min) | (%) | index |
| P1 | 8.5 | 2.6 | 2.1 | 1.549 |
| P2 | 1.7 | 2.5 | 0.6 | 1.546 |
| P3 | 1.8 | 1.9 | 0.5 | 1.536 |
| P4 | 10.1 | 2.5 | 1.9 | 1.549 |
| P5 | 1.8 | 1.9 | 0.5 | 1.595 |

Using the above elastomeric styrene polymer and styrene polymers (P1 to P5), multilayer sheets of various constructions were prepared by means of a T-die system multilayer extruder. The multilayer extruder was a test extruder comprising one single screw extruder having a fulflight screw of 65 mmφ for the center layer, and two single screw extruders having a fulflight screw of 30 mm φ for surface layers, whereby the respective molten resins will join at a feed block to be laminated. Further, the temperature of each cylinder in sheeting was 230° C.

Vacuum Forming

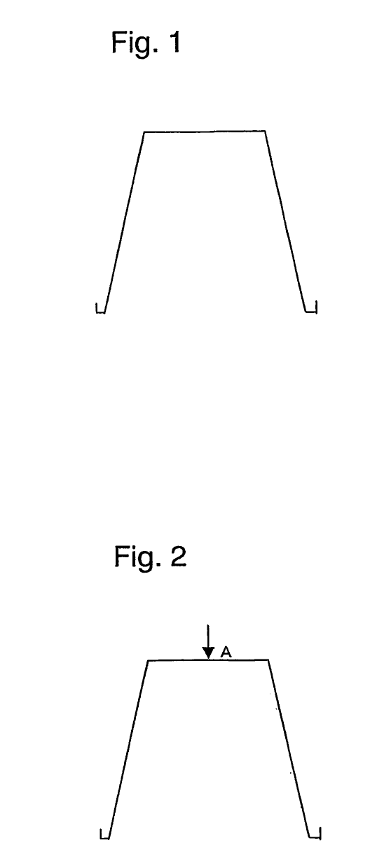

A sample sheet was formed into a shape shown in FIG. 1 by means of a vacuum forming machine of a plug assisted system, manuftured by Asano Seisakusho. Here, the sheet was attached to the vacuum forming machine so that layer A side became the plug side, and the forming condition was such that when the sheet surface reached 120° C. by heating the sheet, the vacuum forming was initiated.

Forming of Embossed Carrier Tape

A sample sheet was slit to have a width of 27 mm, and the formation of an embossed carrier tape (W24 mm, P16 mm, A011.25 mm, B014.8 mm, K05.8 mm) was carried out by means of an air-pressure forming machine for embossed carrier tape, manufactured by EDG Co.

Recycling Test

A sample sheet was pulverized by a pulverizer to a size which is suitable for supplying to an extruder, and under the same conditions as in the preparation of a multilayer sheet, only an extruder of 65 mmφ fulflight screw type was operated to prepare a sheet having a thickness of 0.8 mm. Here, the cylinder temperature was 230° C. for the operation for forming.

O: Good recycling property

X: Poor recycling property (white turbidity)

Various Measuring Methods and Evaluation Standards

Pellets were injection-molded by an in-line screw injection molding machine (IS-50EP, manufactured by Toshiba Corporation) at a cylinder temperature of 230° C. to obtain test pieces which were used as samples for the tests. However, MFR was measured by using the above pellets. The methods used for measuring various compositional values and various physical values were as follows.

(1) Izod impact strength: In accordance with ASTM D256, a notch having a depth of 2.54 mm was imparted to a test piece of 12.7×64×6.4 mm in thickness, and the impact strength was measured at an impact speed of 3.46 m/sec.

(2) MFR: In accordance with JIS K7210, MFR was measured at a temperature of 200° C. under a load of 5 Kgf.

(3) Haze: In accordance with ASTM D1003, the haze was measured by using a test piece of 30×90×2 mm in thickness.

(4) Refractive index: The refractive index was measured by using a test piece of 30×90×2 mm in thickness (measured in an atmosphere of 25° C.).

(5) Determination of the composition: The composition of a polymer was determined by quantitative analysis of each component by pyrolysis gas chromatography using a calibration curve prepared by using a standard substance.

(6) Measurement of wall thickness: The entire wall thickness was measured by a micrometer. The thickness of each layer of a multilayer sheet was obtained in such a manner that the cross-sectional surface of the sheet was smoothed by means of abrasive grains and then observed by an optical microscope to determine the thickness of each layer.

(7) Folding test: A sample sheet prepared by sheet extrusion was folded in two directions i.e. in the withdrawing direction and the direction opposite to the withdrawing direction, whereby formation of cracks in the sheet was visually inspected.

O: Good (no cracks)

X: Poor (cracks observed)

(8) Impact test: A vacuum-formed product was placed as shown in FIG. 2, and a weight (forward end: 10R) of 500 g was dropped from a height of 1 m to the center portion (portion A) of the bottom of the formed product, whereby cracks in the formed product were inspected.

O: Good (no cracks)

X: Poor (cracks observed)

(9) Transparency of a cup as formed product: Measured by visual observation.

O: Good (no fogging observed)

X: Poor (fogging on the surface observed)

(10) Amount of elastomer in elastomeric styrene polymer: The amount of the elastomer in the elastomeric styrene polymer was obtained from the weight ratio of styrene to butadiene in the elastomer preliminarily obtained by an infrared absorption spectrum method and the weight ratio of butadiene in the elastomeric styrene polymer obtained by an infrared absorption spectrum method. The infrared absorption spectrum was measured by means of FTS-575C model, manufactured by Nippon Bio-Rad Laboratories.

(11) Constituting units of the continuous phase in elastomeric styrene polymer: The elastomeric styrene polymer was dissolved in toluene, followed by centrifugal separation. The supernatant was taken, and methanol was added to precipitate the styrene polymer containing styrene monomer units and (meth)acrylate monomer units. This precipitate was dried and dissolved in heavy chloroform to prepare a 2% solution which was used as a sample for measurement. 13C was measured by means of FT-NMR (FX-90Q model, manufactured by JEOL Ltd.), and the constituting units of the continuous phase was obtained from the peak area of the styrene polymer.

(12) Forming property of an embossed carrier tape: The shaping property of an embossed carrier tape obtained by forming was evaluated by visual observation.

⊚: Excellent shaping O: Good shaping

X: Inadequate shaping

(13) Transparency of carrier tape formed product: The transparency of the bottom surface portion of an embossed carrier tape (W24 mm, P16 mm, A011.25 mm, BO14.8 mm, KO5.8 mm) air-pressure formed at a heater temperature of 200° C., was evaluated by means of a haze meter.

O: Good (the increase in haze of the bottom surface portion from the sheet before forming is less than 3).

X: Poor (the increase in haze of the bottom surface portion from the sheet before forming is at least 3)

### Examples 4 to 9 and Comparative Examples 3 to 7

Using materials of P1 to P5, sheets having layer structures as identified in Tables 6 and 7, were prepared. Further, each of the obtained sheets was formed into a cup shaped product as shown in FIG. 1 by a vacuum-forming machine. Evaluation results of such sheets and formed products are shown in Tables 6 and 7.

TABLE 6

| | | | Ex. 4 | Ex. 5 | Ex. 6 | Ex. 7 | Ex. 8 | Ex. 9 |
|---|---|---|---|---|---|---|---|---|
| Sheet (layer | A | Type | P2 | P2 | P3 | P2 | P2 | P2 |
| structure) | | Wall thickness | 0.03 | 0.03 | 0.03 | 0.03 | 0.03 | 0.05 |
| | | (mm) | | | | | | |
| | B | Type | P1 | P1 | P1 | P1 | P4 | P1 |
| | | Wall thickness | 0.75 | 0.5 | 0.75 | 1.75 | 0.75 | 0.75 |
| | | (mm) | | | | | | |
| | C | Type | P2 | P1 | P3 | P2 | P2 | P2 |
| | | Wall thickness | 0.03 | 0.03 | 0.03 | 0.01 | 0.03 | 0.03 |
| | | (mm) | | | | | | |

| | | | | | | | |
|---|---|---|---|---|---|---|---|
| | Total wall thickness (mm) | 0.81 | 0.56 | 0.81 | 1.79 | 0.81 | 0.83 |
| (Productivity of | Folding test | ◯ | ◯ | ◯ | ◯ | ◯ | ◯ |
| sheet) | | | | | | | |
| (Physical properties | Transparency (visual observation) | ◯ | ◯ | ◯ | ◯ | ◯ | ◯ |
| of sheet) | Haze % | 1.4 | 1.3 | 1.4 | 1.8 | 1.3 | 1.4 |
| (Cup: Formed product | Transparency (visual observation) | ◯ | ◯ | ◯ | ◯ | ◯ | ◯ |
| (physical properties | Impact test | ◯ | ◯ | ◯ | ◯ | ◯ | ◯ |
| of formed product) | | | | | | | |
| Recycled sheet | Haze % | 1.9 | 1.9 | 4.3 | 1.8 | 1.8 | 1.9 |
| (Recycling | Recycling properties | ◯ | ◯ | ◯ | ◯ | ◯ | ◯ |
| properties) | | | | | | | |

TABLE 7

| | | | Comp. | Comp. | Comp. | Comp. | Comp. |
|---|---|---|---|---|---|---|---|
| | | | Ex. 3 | Ex. 4 | Ex. 5 | Ex. 6 | Ex. 7 |
| Sheet (layer | A | Type | | | P2 | P5 | |
| structure) | | Wall thickness | | | 0.15 | 0.05 | |
| | | (mm) | | | | | |
| | B | Type | P1 | P4 | P1 | P1 | P2 |
| | | Wall thickness | 0.8 | 0.8 | 0.65 | 0.75 | 0.8 |
| | | (mm) | | | | | |
| | C | Type | | | P2 | P5 | |
| | | Wall thickness | | | 0.03 | 0.03 | |
| | | (mm) | | | | | |

| | | | | | | |
|---|---|---|---|---|---|---|
| | Total wall thickness (mm) | 0.8 | 0.8 | 0.83 | 0.83 | 0.8 |
| (Productivity of | Folding test | ◯ | ◯ | X | ◯ | X |
| sheet) | | | | | | |
| (Physical properties | Transparency (visual observation) | ◯ | ◯ | ◯ | ◯ | ◯ |
| of sheet) | Haze % | 2 | 1.8 | 1.4 | 1.5 | 1 |
| (Cup: Formed product | Transparency (visual observation) | X | X | ◯ | ◯ | X |
| (physical properties | Impact test | ◯ | ◯ | ◯ | ◯ | X |
| of formed product) | | | | | | |
| Recycled sheet | Haze % | 2 | 1.8 | 1.8 | 36.2 | 0.8 |
| (Recycling | Recycling properties | ◯ | ◯ | ◯ | X | ◯ |
| properties) | | | | | | |

### Examples 10 to 13 and Comparative Examples 8 to 10

Using materials of P1 to P4, sheets having layer structures as identified in Tables 8 and 9, were prepared. Further, each of the obtained sheets was formed into an embossed carrier tape by an air-pressure molding machine. Evaluation results of such sheets and formed products are shown in Tables 8 and 9.

TABLE 8

| | | | Ex. 10 | Ex. 11 | Ex. 12 | Ex. 13 |
|---|---|---|---|---|---|---|
| Sheet | A | Type | P2 | P3 | P2 | P3 |
| | | Wall thickness | 0.03 | 0.03 | 0.03 | 0.03 |
| | | (mm) | | | | |
| | B | Type | P1 | P1 | P4 | P4 |
| | | Wall thickness | 0.24 | 0.24 | 0.24 | 0.24 |
| | | (mm) | | | | |
| | C | Type | P2 | P3 | P2 | P3 |
| | | Wall thickness | 0.03 | 0.03 | 0.03 | 0.03 |
| | | (mm) | | | | |

| | | | | |
|---|---|---|---|---|
| Total wall thickness | 0.3 | 0.3 | 0.3 | 0.3 |
| (mm) | | | | |

| | | | | | |
|---|---|---|---|---|---|
| | Forming temp. | | | | |
| | (° C.) | | | | |
| Carrier tape | 180 | ◯ | ◯ | ◯ | ◯ |
| forming | 200 | ⊚ | ⊚ | ⊚ | ⊚ |
| properties | 220 | ⊚ | ⊚ | ⊚ | ⊚ |

| | | | | |
|---|---|---|---|---|
| Transparency of carrier tape | ◯ | ◯ | ◯ | ◯ |

TABLE 9

| | | | Comp. | Comp. | Comp. |
|---|---|---|---|---|---|
| | | | Ex. 8 | Ex. 9 | Ex. 10 |
| Sheet | A | Type | | | |
| | | Wall thickness | | | |
| | | (mm) | | | |
| | B | Type | P1 | P4 | P2 |
| | | Wall thickness | 0.3 | 0.3 | 0.3 |
| | | (mm) | | | |
| | C | Type | | | |
| | | Wall thickness | | | |
| | | (mm) | | | |

| | | |
|---|---|---|
| Total wall thickness | 0.3 | 0.3 |
| (mm) | | |

| | | | | |
|---|---|---|---|---|
| | Forming temp. (° C.) | | | |
| Carrier tape | 180 | ◯ | ◯ | X |
| forming | 200 | ◯ | ◯ | ◯ |
| properties | 220 | ⊚ | ⊚ | ⊚ |

| | | | |
|---|---|---|---|
| Transparency of carrier tape | X | X | X |

### INDUSTRIAL APPLICABILITY

The sheet of the present invention is a transparent sheet which is free from deterioration in the appearance (transparency) even when subjected to vacuum forming and which is excellent in physical strength and excellent in economical efficiency and recycling properties. The obtained transparent sheet excellent in vacuum forming properties, is suitable particularly for food packaging containers or electronic component packaging containers.

1. A sheet made of a resin composition comprising the following elastomeric styrene polymer, and component (B1), component (B2) and component (B3), in a mass ratio of from 98/2 to 80/20:
Elastomeric styrene polymer: An elastomeric styrene polymer which comprises (I) from 40 to 95 parts by mass of a continuous phase of a copolymer comprising from 20 to 80 mass % of styrene monomer units, from 80 to 20 mass % of (meth)acrylate monomer units and from 0 to 10 mass % of units of other vinyl monomers copolymerizable with such monomers, and (II) from 60 to 5 parts by mass of a dispersed phase of a graft copolymer having from 20 to 90 parts by mass of graft branches of a copolymer comprising from 20 to 80 mass % of styrene monomer units, from 80 to 20 mass % of (meth)acrylate monomer units and from 0 to 10 mass % of units of other vinyl monomers copolymerizable with such monomers, grafted to from 10 to 80 parts by mass of an elastomer, wherein the volume average particle size of the dispersed phase is from 0.1 to 0.6 μm, and the difference in the refractive index between the continuous phase and the dispersed phase is not more than 0.05;
Component (B1): An aminocarboxylic acid having at least 6 carbon atoms, a lactam, or a salt of a diamine with a carboxylic acid, having at least 6 carbon atoms;
Component (B2): At least one diol compound selected from the following chemical formulae (1) to (3): 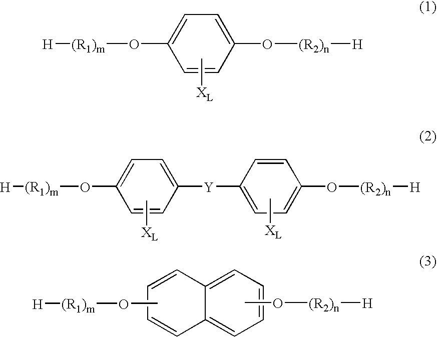
wherein R₁ is an ethylene oxide group, R₂ is an ethylene oxide group or a propylene oxide group, Y is a covalent bond, a C₁₋₆ alkylene group, a C₁₋₆ alkylidene group, a C₇₋₁₇ cycloalkylidene group, a C₇₋₁₇ arylalkylidene group, O, SO, SO₂, CO, S, CF₂, C(CF₃)₂ or NH, L in X_{L} is an integer of from 1 to 4, and each of m and n is an integer of at least 16;
Component (B3): A polyether ester amide having a C₄₋₂₀ dicarboxylic acid copolymerized.

2. A multilayer sheet which comprises a substrate layer made of a thermoplastic resin (C) and a surface layer made of the resin composition as defined in claim 1, formed on at least one side of the substrate layer.

3. The multilayer sheet according to claim 2, wherein the substrate layer is made of the following elastomeric styrene polymer:
Elastomeric styrene polymer: An elastomeric styrene polymer which comprises (I) from 40 to 95 parts by mass of a continuous phase of a copolymer comprising from 20 to 80 mass % of styrene monomer units, from 80 to 20 mass % of (meth)acrylate monomer units and from 0 to 10 mass % of units of other vinyl monomers copolymerizable with such monomers, and (II) from 60 to 5 parts by mass of a dispersed phase of a graft copolymer having from 20 to 90 parts by mass of graft branches of a copolymer comprising from 20 to 80 mass % of styrene monomer units, from 80 to 20 mass % of (meth)acrylate monomer units and from 0 to 10 mass % of units of other vinyl monomers copolymerizable with such monomers, grafted to from 10 to 80 parts by mass of an elastomer, wherein the volume average particle size of the dispersed phase is from 0.1 to 0.6 μm, and the difference in the refractive index between the continuous phase and the dispersed phase is not more than 0.05.

4. The multilayer sheet according to claim 2, wherein the substrate layer is made of the following component (D):
Component (D): An elastomeric styrene polymer which comprises from 99 to 85 parts by mass of a continuous phase comprising from 35 to 75 mass % of styrene monomer units and from 65 to 25 mass % of (meth)arylate monomer units, and from 1 to 15 parts by mass of a dispersed phase of an elastomer.

5. A multilayer sheet which comprises a substrate layer of an elastomeric styrene polymer comprising from 1 to 20 parts by mass of a dispersed phase of an elastomer comprising from 30 to 50 mass % of styrene monomer units and from 70 to 50 mass % of butadiene monomer units, and from 99 to 80 parts by mass of a continuous phase of a polymer comprising from 35 to 75 mass % of styrene monomer units and from 65 to 25 mass % of (meth)acrylate monomer units, and a surface layer of a styrene polymer comprising from 35 to 75 mass % of styrene monomer units and from 65 to 25 mass % of (meth)arylate monomer units, formed on each side of the substrate layer.

6. The sheet according to claim 5, wherein the styrene polymer comprises at most 3 parts by mass of a dispersed phase of an elastomer comprising from 30 to 50 mass % of styrene monomer units and from 70 to 50 mass % of butadiene monomer units, and from 97 to less than 100 parts by mass of a continuous phase of a polymer comprising styrene monomer units and (meth)arylate monomer units.

7. The sheet according to any one of claims 2 to 6, wherein the total thickness is from 50 to 2,000 μm, and the thickness of the surface layer is from 3 to 20% of the total thickness.

8. The sheet according to any one of claims 5 to 7, wherein the refractive index of the surface layer at 25° C. is within a range of +0.01 of the refractive index of the substrate layer.

9. A formed product which comprises the sheet as defined in any one of claims 1 to 8.

10. An electronic component packaging container which comprises the sheet as defined in any one of claims 1 to 8.

11. A food product packaging container which comprises the sheet as defined in any one of claims 1 to 8.

12. An embossed carrier tape which comprises the sheet as defined in any one of claims 1 to 8.

13. A soft tray which comprises the sheet as defined in any one of claims 1 to 8.

14. An electronic component package which comprises the sheet as defined in any one of claims 1 to 8.
